(19) United States
(12) Patent Application Publication
(10) Pub. No.: US 2009/0242110 A1
(43) Pub. Date: Oct. 1, 2009

(54) Method for manufacturing polarizer

(75) Inventor: Jinichi Kasuya, Tokyo (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 12/381,929

(22) Filed: Mar. 18, 2009

(30) Foreign Application Priority Data
Mar. 28, 2008 (JP) JP2008-086395

(51) Int. Cl. B32B 37/00; B29D 11/00

(52) U.S. Cl. 156/250; 264/1.31

(57) ABSTRACT

A method for manufacturing a polarizer includes: transferring a ridge-trough pattern with a mold onto a surface of a substrate formed with a transparent medium; forming a metal layer so as to at least fill a trough portion of the ridge-trough pattern transferred on the substrate; grinding the metal layer and a ridge portion of the ridge-trough pattern transferred on the substrate to form a periodic pattern of a material of the metal layer and the transparent medium, where a period of the ridge-trough pattern is not longer than a wavelength of an incident light flux.

This application is based on Japanese Patent Application No. 2008-086395 filed on Mar. 28, 2008, in Japanese Patent Office, the entire content of which is hereby incorporated by reference.

### TECHNICAL FIELD

The present invention relates to a method for manufacturing a polarizer, and in particular, to a method for manufacturing a wire-grid polarizer.

### BACKGROUND

A conventional polarizer, especially a beam splitter, has been manufactured by the following process. There is formed a polarization separating film composed of an optical multilayer film on a mirror-finished slope of a glass block in a shape of a right-triangle pole. A glass block with the polarization separating film on its mirror-finished slope and a glass block without the polarization separating film on its mirror-finished slope are stuck with their mirror-finished slopes facing each other to form a shape of a cube. Then, a light-incident surface and a light-emerging surface of the cube are ground to form optical surfaces.

In another manufacturing method, as is disclosed in Unexamined Japanese Patent Application Publication (JP-A) No. 2000-143264, a layered body is formed by piling a multilayer film on a parallel flat plate of transparent medium to form a polarization separating surface, and jointing provisionally a plurality of the parallel flat plates with each the edges shifted along a slope inclining at 45° with a horizontal direction. The layered body thus formed is cut along the direction perpendicular to a layered surface, then, the provisional joining is removed and the layered body is cut into the prescribed dimensions to manufacture beam splitters.

On the other hand, there is known a wire-grid polarizer as a polarization beam splitter in place of an optical multilayer film. JP-A No. 2004-252058 discloses a method for manufacturing a wire-grid polarizer as follows. A pattern with microscopic relief structure on a glass interface is formed through photo-lithography technology. A concave pattern section on the glass interface is etched to the prescribed depth by ion etching, and a metal film is formed on the glass interface, to form a wire-grid polarizer.

However, in the polarizer employing an optical multilayer film as a polarization separating surface, layering multilayer films consumes much time, resulting in cost increase. Further, its property widely varies due to fluctuations of forming conditions for multilayer films. Strict control of film forming conditions is required to stabilize the property, which also results in cost increase.

Further, in the recent laser optical system, a trend of downsizing urges a use of a laser beam emitting divergent light, which requires a polarizer with less dependence on a light angle. However, it is difficult to lessen dependence on the light angle in a polarization separating surface formed with a multilayer film.

The method described in JP-A No. 2004-252058 can decrease the dependence on the light angle, but the method affects the environment because it uses a poisonous gas in the course of ion etching. Further, employment of ion etching lowers manufacturing efficiency.

### SUMMARY

The present invention has been achieved, in view of the aforesaid circumstances, to provide a method of manufacturing a polarizer, which has ability to manufacture polarizers having lower degree of dependence on the light angle and uniform properties, stably at a low cost with less adverse effect on the environment.

The method is provided by transferring a ridge-trough pattern with a mold onto a surface of a substrate formed with a transparent medium, where a period of the ridge-trough pattern is not longer than a wavelength of an incident light flux; by forming a metal layer so as to at least fill a trough portion of the ridge-trough pattern transferred on the substrate; and by grinding the metal layer and a ridge portion of the ridge-trough pattern transferred on the substrate, from a direction that the metal layer is formed on the substrate, to form a periodic pattern of a material of the metal layer and the transparent medium.

These and other objects, features and advantages according to the present invention will become more apparent upon reading of the following detailed description along with the accompanied drawings.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

Each of FIGS. 1(a)-1(c) is a pattern diagram for illustrating structures and actions of a wire-grid polarizer of a flat plate type;

Each of FIGS. 2(a)-2(d) is a sectional pattern diagram for illustrating a method of manufacturing a wire-grid polarizer of a flat plate type;

FIG. 3 is a pattern diagram for illustrating structures and actions of a wire-grid polarizer of a cube type;

Each of FIGS. 4(a)-4(d) is a sectional pattern diagram for illustrating the first manufacturing embodiment of a method of manufacturing a wire-grid polarizer of a cube type;

Each of FIGS. 5(a)-5(c) is a perspective view showing a method to obtain a wire-grid polarizer of a cube type from an aggregate of wire-grid polarizers of a cube type; and

Each of FIGS. 6(a)-6(c) is a sectional pattern diagram for illustrating the second manufacturing embodiment of a method of manufacturing a wire-grid polarizer of a cube type.

### DESCRIPTION OF EMBODIMENTS

The invention will be explained as follows, based on the illustrated embodiments, to which, however, the invention is not limited. In the meantime, the portions which are the same or similar are given the same number, and overlapping illustrations are omitted.

First, structures and actions of a wire-grid polarizer of a flat plate type (a plate-type wire-grid polarizer), which is a first embodiment of a polarizer relating to the invention, will be explained as follows, referring to FIGS. 1(a)-1(c). Each of FIGS. 1(a)-1(c) is a pattern diagram for illustrating structures and actions of a plate-type wire-grid polarizer representing the first embodiment of a polarizer, FIG. 1(a) is a perspective view showing an overall structure a plate-type wire-grid polarizer, FIG. 1(b) is a partial enlarged perspective view of area A within broken lines which is the vicinity of a polarization plane in FIG. 1(a), and FIG. 1(c) is a perspective view showing polarization separating actions of a plate-type wire-grid polarizer.

In FIG. 1(a), plate-type wire-grid polarizer 1 is a rectangular parallel plate. Wire-grid polarizer 1 includes glass substrate 11 representing a substrate formed with a transparent medium, and polarization plane 13 formed on transfer surface 11a of glass substrate 11. A size of plate-type wire-grid polarizer 1 is indicated with (width a)×(length b)×(thickness c) which is determined depending on the intended purpose, and each of a, b and c is 1 millimeter-several tens of millimeters. Polarization plane 13 and opposing surface 11r which faces polarization plane 13 in glass substrate 11 are optical surfaces.

As a substrate formed with transparent medium, it is possible to use optical resins such as PC (polycarbonate) and PMM (polymethylmethacrylate) in place of the glass substrate.

In FIG. 1(b), polarization plane 13 is formed by embedding metal wires 15 in glass substrate 11 to be in a parallel striped shape at regular intervals. The metal wires 15 extend along transfer surface 11a of glass substrate 11 in parallel to side 11e of transfer surface 11a, namely, in the direction y in FIG. 1(a). Period p of wires 15 needs to be not more than a wavelength of light to be used. The period p is preferably a half of the wavelength of light or less (for example, p is 200 nm or less when using for light with wavelength of 400 nm), and is more preferably a tenth of the wavelength of light or less. Width d of wires 15 is preferably a half of period p or less (for example, d is 100 nm or less, when p is 200 nm), and height h is preferably the same as width d or more.

In FIG. 1(c), light L has polarization components in two directions which bisect each other at right angles on a plane that is perpendicular to a traveling direction of the light L (z direction in FIG. 1(a)). In the polarization components, a polarization component that is in parallel with a longitudinal direction (y direction in FIG. 1(a)) of wires 15 of wire-grid polarizer 1 is assumed to be H polarized light; and a polarization component that is perpendicular (x direction in FIG. 1(a)) to the longitudinal direction of wires 15 is assumed to be V polarized light. In this case, the wire-grid polarizer 1 shows polarization separating actions so as to transmitting only V polarized light of the light L entering polarization plane 13, and to reflect H polarized light.

Next, a method for manufacturing the aforesaid plate-type wire-grid polarizer 1 will be explained as follows, referring to FIGS. 2(a)-2(d). Each of FIGS. 2(a)-2(d) is a sectional pattern diagram for illustrating a method of manufacturing plate-type wire-grid polarizer 1. In this case, an explanation will be given to a method of manufacturing wire-grid polarizer 1 employing a nano-imprint method.

As shown in FIG. 2(a), mold 101 is manufactured by a method such as an electron beam drawing (mold manufacturing process). The mold 101 has ridge-trough pattern 103 in comb-like shape with period p, width d and height h2. The height h2 is set to be higher than the height h of wires 15 of wire-grid polarizer 1. On the ridge-trough pattern 103 of the mold 101 thus manufactured, there is coated release agent 105.

In FIG. 2(b), mold 101 on which release agent 105 is coated is pushed against transfer surface 11a of rectangular flat plate-shaped glass substrate 11 having thickness c. Thus, ridge-trough pattern 103 in a comb-like shape is transferred onto the transfer surface 11a, and ridge-trough pattern 11b is formed (transferring process). In this case, the mold 101 and the glass substrate 11 are heated as occasion demands. After transferring is completed, the mold 101 is released.

In FIG. 2(c), metal layer 107 is formed on glass substrate 11 on which ridge-trough pattern 11b is formed, so as to fill up the trough portion of the ridge-trough pattern 11b and to cover the transfer surface 11a (metal layer forming process). As a material for the metal layer 107, Al, Au, Ag, Cu and Ni can be used. As a method for forming the metal layer 107, methods such as vacuum evaporation, spattering and coating can be used.

Then, the metal layer 107 thus formed and ridge-trough pattern 11b of glass substrate 11 are ground from the side that the metal layer 107 is formed on the substrate until the moment when the position of broken line B in FIG. 2(c) appears, namely, the periodic pattern of glass substrate 11 and metal layer 107 appears, to be finished to become an optical surface (grinding process). Further, opposing surface 11r of the glass substrate 11 is also ground to be finished to become an optical surface (opposing surface grinding process). Incidentally, grinding of the opposing surface 11r is not indispensable, when employing glass substrate 11 whose opposing surface 11r is finished to be an optical surface from the beginning.

FIG. 2(d) shows a structure of aggregate 1a of plate-type wire-grid polarizers manufactured in the aforesaid way. Metal wires 15 are embedded in glass substrate 11 to be in a parallel striped shape at regular intervals with period p, width d and height h. Metal wires 15 extend in the direction perpendicular to the sheet of FIG. 2(d) (y direction) along transfer surface 11a of glass substrate 11. By cutting the aggregate 1a of plate-type wire-grid polarizers through a method such as dicing into a necessary dimension, plate-type wire-grid polarizer 1 shown in FIGS. 1(a)-1(c) is completed (polarizer forming process).

As stated above, in the method for manufacturing plate-type wire-grid polarizer 1 representing the first embodiment of a polarizer, a ridge-trough pattern is transferred onto a glass substrate in flat-plate shape with a mold (transfer process), and a metal layer is formed so as to fill up the trough portions of the ridge-trough pattern (metal layer forming process). Then, the formed metal layer is ground to form a periodic pattern of materials of the metal layer and the substrate formed with the transparent medium, to manufacture a wire-grid (grinding process). Thereby, it is possible to provide a method of manufacturing a polarizer by which a polarizer having lower degree of dependence for a light angle and having uniform properties can be manufactured stably at a low cost with less adverse effect on the environment.

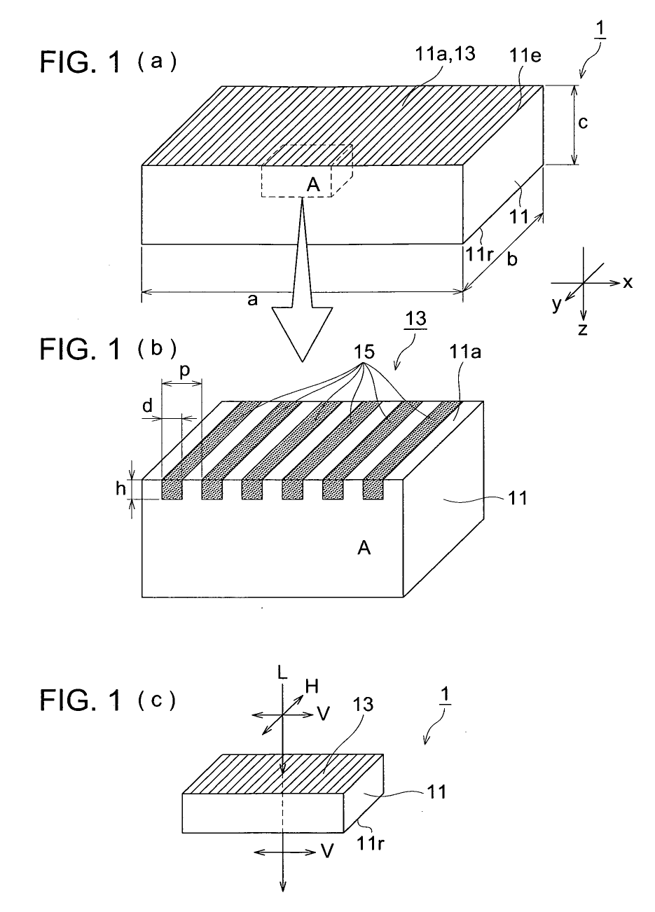

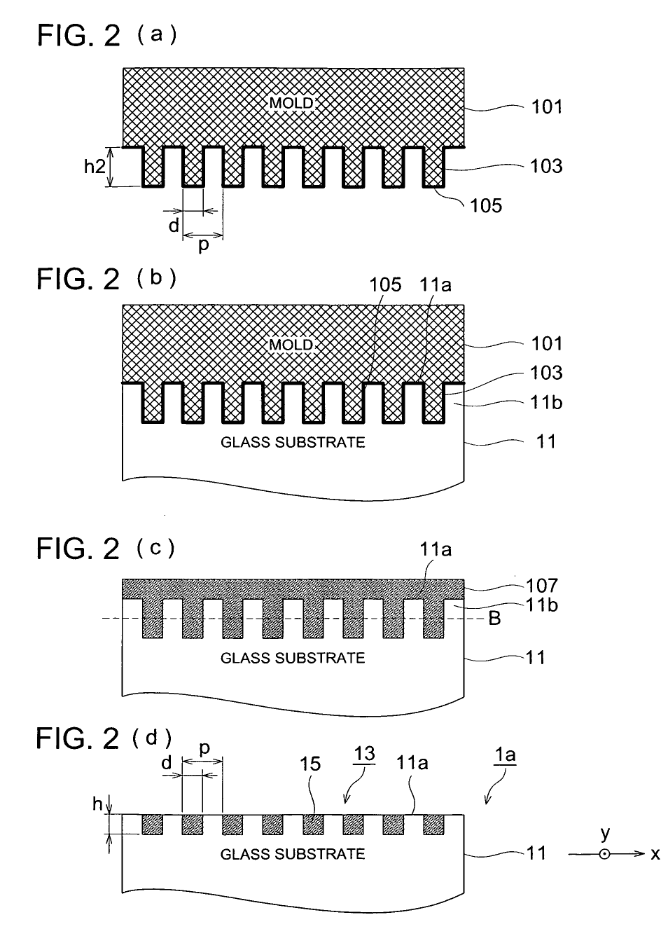

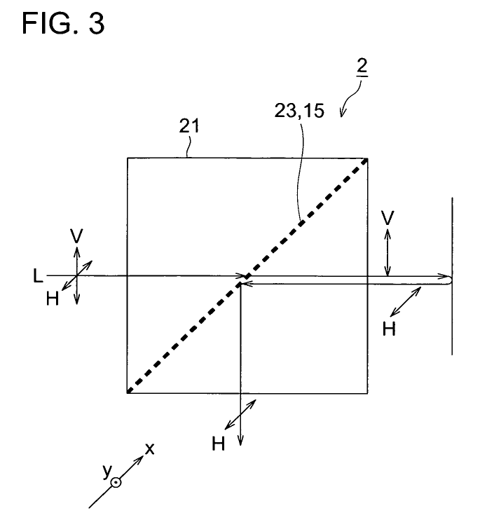

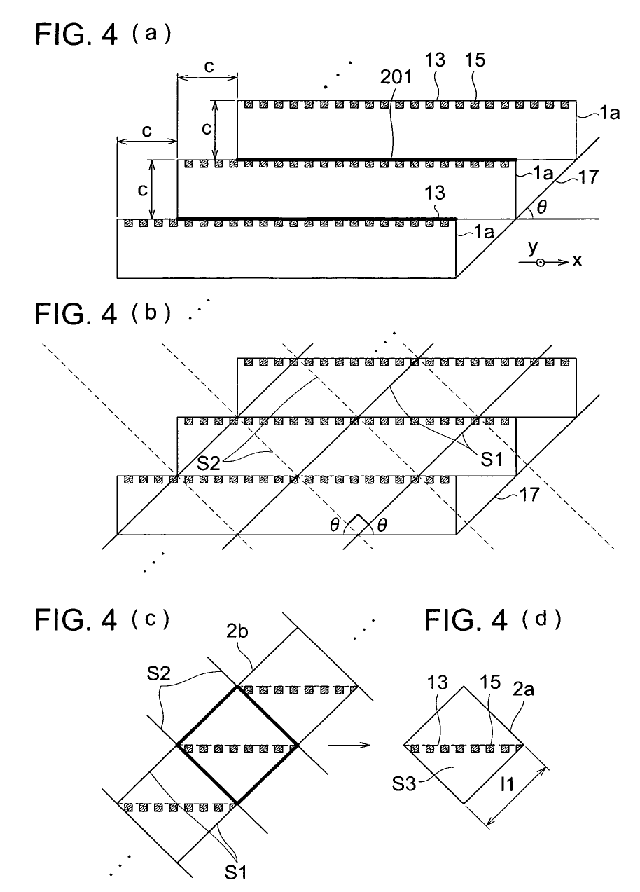

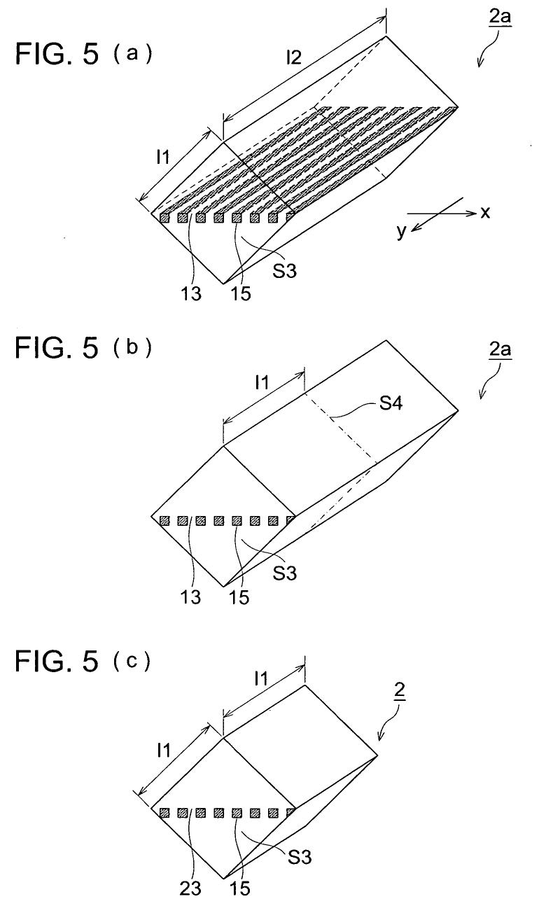

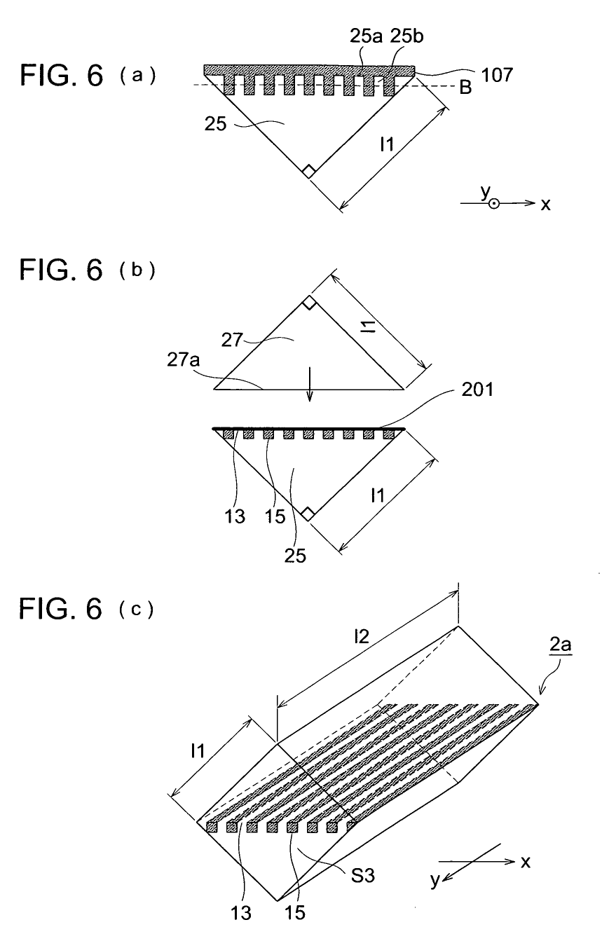

Next, constructions and operations of a wire-grid polarizer of a cube type (a cube-type wire-grid polarizer) representing the second embodiment of a polarizer will be explained as follows, referring to FIG. 3. FIG. 3 is a schematic diagram for illustrating a pattern diagram for illustrating structures and actions of a cube-type wire-grid polarizer.

In FIG. 3, cube-type wire-grid polarizer 2 includes cubic glass block 21 and polarization plane 23 provided on a plane connecting opposing two sides of glass block 21. The structure of polarization plane 23 is the same as that shown in FIG. 1(b), and wires 15 are embedded in the glass block in a striped shape at regular intervals, in the direction perpendicular to the sheet of FIG. 3 (y direction). A size of cube-type wire-grid polarizer 2 is determined properly in accordance with the intended use, and a length of each side is from 1 millimeters to several tens of millimeters.

Light L has polarization components in two directions which bisect each other at right angles on a plane that is perpendicular to a traveling direction of the light L. In the polarization components, polarized light that is in parallel with a longitudinal direction (y direction) of wires 15 of cube-type wire-grid polarizer 2 is assumed to be H polarized light, and polarized light in the direction (x direction) perpendicular to the H polarized light is assumed to be V polarized light. In this case, the cube-type wire-grid polarizer 2 shows polarization separating actions to transmit only V polarized light of light L entering polarization plane 23 obliquely, and to reflect the H polarized light.

In the embodiment, the wire-grid polarizer 2 shown in FIG. 3 includes embedded wires 15 extending in the direction perpendicular to the sheet of FIG. 3. However, the direction of the wires 15 may be determined in accordance with a direction of polarized light to be transmitted or reflected. For example, if the embedded wires 15 extend in the direction parallel to the sheet, the polarizer transmits polarized light in the direction perpendicular to the sheet, and reflects polarized light in the direction parallel to the sheet.

Next, a manufacturing method of the aforesaid cube-type wire-grid polarizer 2 represented as a first manufacturing embodiment will be explained as follows, referring to FIGS. 4(a)-4(d) and FIGS. 5(a)-5(c). Each of FIGS. 4(a)-4(d) is a sectional pattern diagram for illustrating the method of manufacturing aggregate 2a of cube-type wire-grid polarizers as the first manufacturing embodiment. The aggregate 2a of cube-type wire-grid polarizers can be manufactured by layering aggregates 1a of plate-type wire-grid polarizers shown in FIGS. 2(a)-2(d).

In FIG. 4(a), a plurality of aggregates 1a of plate-type wire-grid polarizers each shown in FIG. 2(d) are jointed by being layered through adhesive agents 201 (jointing process). In this process, the aggregates 1a are layered with being shifted by an amount equivalent to thickness c of aggregates 1a of the plate-type wire-grid polarizers in the direction (x direction) perpendicular to longitudinal direction (y direction) of wires 15, in other words, are layered such that angle θ formed by straight line 17 connecting end surfaces of aggregates 1a of plate-type wire-grid polarizers and by polarization planes 13 of aggregates 1a of the plate-type wire-grid polarizers equals 45°.

In FIG. 4(b), layered aggregates 1a of plate-type wire-grid polarizers are cut into layered divisions 2b shown in FIG. 4(c) through dice cutting or by a wire-saw at a predetermined interval along first planes S1 that form angle θ of 45° with polarization planes 13 of the plane wire-grid polarizers. Thus, layered divisions 2b shown in FIG. 4(c) are obtained (first cutting process).

In FIG. 4(c), cut surfaces along first planes S1 of layered division 2b obtained through the cutting are ground (first grinding process). Further, layered division 2b is cut along second planes S2 which are perpendicular to the first planes S1, at positions such that each polarization planes 13 is sandwiched between the second planes (second cutting process), and cut surface along second planes S2 obtained through the cutting is ground (second grinding process). Owing to this, it is possible to cut out aggregate 2a of cube-type wire-grid polarizers boxed by thick lines in FIG. 4(c). FIG. 4(d) shows the aggregate 2a of the cube-type wire-grid polarizers obtained by the cutting.

In FIG. 4(d), aggregate 2a of the cube-type wire-grid polarizers is cut out in a rectangular parallelepiped shape, and an antireflection film is coated on each of four side surfaces of the aggregate 2a in a rectangular parallelepiped shape (antireflection film forming process). The aggregate 2a of the cube-type wire-grid polarizers whose four side surfaces are coated with antireflection films has square end surface S3. Polarization plane 13 is formed on a diagonal line connecting a pair of opposite angles of the end surface S3. On polarization plane 13, wires 15 are arranged at regular intervals extending in the direction perpendicular to the sheet of FIG. 4(d). Length l1 of a side of end surface S3 is c·cos θ.

Each of FIGS. 5(a)-5(c) is a perspective view showing a method to obtain a cube-type wire-grid polarizer 2 shown in FIG. 3 from aggregate 2a of cube-type wire-grid polarizers obtained from the method of FIGS. 4(a)-4(d).

FIG. 5(a) is a perspective view of aggregate 2a of cube-type wire-grid polarizers shown in FIG. 4(d). The aggregate 2a of the cube-type wire-grid polarizers has a rectangular parallelepiped shape with length l2 and with end surface S3 whose one side is l1 in length. In the aggregate 2a, there is polarization plane 13 on which wires 15 are arranged at regular intervals on the diagonal line connecting a pair of opposite angles of the end surface S3. The wires 15 are arranged in the direction (y direction) of length l2 of the rectangular parallelepiped shape.

In FIG. 5(b), aggregate 2a of cube-type wire-grid polarizers is cut through a method such as dicing along plane S4 that is parallel to the end surface S3 at a position of length l1 in the direction of length l2 (y direction) of the rectangular parallelepiped shape from the end surface S3 (polarizer forming process). The cube-type wire-grid polarizer 2 obtained in the aforesaid way is shown in FIG. 5(c).

When wires 15 extend in parallel direction to the end surface S3, aggregates 1a may be shifted in the longitudinal direction (y direction) of wires 15 to be jointed in the aforesaid jointing process.

As stated above, according to the first manufacturing embodiment which is the method of manufacturing cube-type wire-grid polarizer 2 as the second embodiment of the polarizer, aggregates 1a of plate-type wire-grid polarizers are shifted by an amount equivalent to its thickness in the direction perpendicular to the wires 15 and is layered to be jointed, and is cut along planes S1 parallel to a plane connecting end surfaces of aggregates 1a and along planes S2 perpendicular to the planes S1 to be the cube-type wire-grid polarizers 2. By manufacturing wire-grid polarizers in the aforesaid manner, it is possible to manufacture polarizers which have less angle dependence and have uniform properties, stably and at low cost with less adverse effect on the environment.

Next, another manufacturing method of the cube-type wire-grid polarizer represented as the second manufacturing embodiment will be explained as follows, referring to FIGS. 6(a)-6(c). Each of FIGS. 6(a)-6(c) is a pattern diagram for illustrating the method of manufacturing cube-type wire-grid polarizer 2 as the second manufacturing embodiment. In the manufacturing method, aggregate 2a of cube-type wire-grid polarizers is manufactured through the method shown in FIGS. 2(a)-2(d) by using glass substrates in a right-triangle pole shape, which is different from the first manufacturing embodiment.

In FIG. 6(a), glass substrate 25 is a right-triangle pole in shape, and a length of each of two sides which form a right angle is l1, and a length in the direction (y direction) perpendicular to the sheet of FIG. 6(a) is l2. Two surfaces making the right angle are ground to be optical surfaces in advance.

In this case, metal layer 107 in a form of a comb-like shape is formed on transfer surface 25a that is a hypotenuse surface facing the right angle of the right-triangle pole, through the method shown in FIGS. 2(a)-2(d) (metal layer forming process). Then, comb-like-shaped metal layer 107 thus formed and ridge-trough pattern 25b of glass substrate 25 are ground to be finished into an optical surface, until the moment when the position of broken line B in FIG. 6(a) appears, namely, the ridge portion of the transfer surface 25a appears (grinding process).

In FIG. 6(b), glass substrate 25 which has been finished in terms of a grinding process, includes polarization plane 13 in which wires 15 are arranged at regular intervals on the hypotenuse surface facing the right angle. There are prepared the glass substrate 25 which has been finished in terms of grinding process and glass substrate 27 which is a right-triangle pole in a shape that two sides with length l1 are arranged between the right angle in the right-triangle and hypotenuse surface 27a facing the right angle is ground into an optical surface in advance. The glass substrate 25 and the glass substrate 27 are jointed through adhesive agents 201, with both hypotenuse surfaces facing each other (jointing process). This process provides aggregate 2a of cube-type wire-grid polarizers in a rectangular parallelepiped shape, and antireflection film is coated on four sides of the rectangular parallelepiped shape (antireflection film forming process).

FIG. 6(c) shows aggregate 2a of cube-type wire-grid polarizers coated with antireflection films, which is the same as that shown in FIG. 5(a). After that, in the same way as in FIG. 5(b), the aggregate 2a of cube-type wire-grid polarizers is cut through a method such as dicing along plane S4 in FIG. 5(b) parallel to end surface S3 at a position of length l1 from the end surface S3 in the direction of length l2 (y direction) of the rectangular parallelepiped shape, whereby, cube-type wire-grid polarizer 2 shown in FIG. 5(c) is obtained also from aggregates 2a of FIG. 6(c) (polarizer forming process).

As stated above, according to the second manufacturing embodiment which is the method of manufacturing the cube-type wire-grid polarizer 2 as the second embodiment of a polarizer, a ridge-trough pattern is transferred onto a hypotenuse surface of a glass substrate in a shape of a right-triangle pole, by using a mold, and a metal layer is formed so that a trough portion of the ridge-trough pattern may be filled up. A wire-grid is formed by grinding the metal layer thus formed to form a periodic pattern of materials of the metal layer and the substrate formed with the transparent medium.

The glass substrate in a right-triangle-pole shape on which a wire-grid is formed and a glass substrate in a right-triangle-pole shape on which a wire-grid is not formed, are jointed with the hypotenuse surface with a wire-grid and the hypotenuse surface without a wire-grid facing each other. Thereby, it is possible to manufacture polarizers which have less angle dependence and have uniform properties, stably and at low cost with less adverse effect on the environment.

According to the above described embodiments, a wire grid is manufactured by transferring a ridge-trough pattern with a mold onto a surface of a substrate formed with a transparent medium, by forming a metal layer so as to fill a trough portion of the ridge-trough pattern, and by grinding the metal layer and a ridge portion of the ridge-trough pattern to form a periodic pattern of a material of the metal layer and the transparent medium. Thereby, it is possible to manufacture polarizers which have less angle dependence and have uniform properties, stably and at low cost with less adverse effect on the environment.

While the embodiments of the present invention have been described using specific terms, such description is for illustrative purposes only, and it is to be understood that changes and variations may be made without departing from the spirit or scope of the appended claims.

For example, with respect to the detailed structures and detailed operations of each structure included in the method of manufacturing a polarizer relating to the invention, they can be varied without departing from the spirit and scope of the invention.

1. A method for manufacturing a polarizer comprising:
transferring a ridge-trough pattern with a mold onto a surface of a substrate formed with a transparent medium, a period of the ridge-trough pattern being not longer than a wavelength of an incident light flux;
forming a metal layer so as to at least fill a trough portion of the ridge-trough pattern transferred on the substrate; and
grinding the metal layer and a ridge portion of the ridge-trough pattern transferred on the substrate, from a direction that the metal layer is formed on the substrate, to form a periodic pattern of a material of the metal layer and the transparent medium.

2. The method of claim 1,
wherein the forming a metal layer is forming a metal layer so as to fully fill the trough portion of the ridge-trough pattern and to cover a surface of the ridge-trough pattern.

3. The method of claim 1,
wherein the substrate is a parallel plate in shape, and the method further comprising:
forming a polarizer by cutting the substrate on which the periodic pattern is formed, into a predetermined dimension.

4. The method of claim 1,
wherein the substrate is a parallel plate in shape,
the periodic pattern is formed on one surface of the substrate, and
the method further comprising:
jointing a plurality of the substrates on which the periodic patterns are formed by layering the substrates with
a surface including the periodic pattern of one of the substrates and
a surface opposing to a surface including the periodic pattern of another of the substrates, facing each other through an adhesive;
cutting the jointed substrates into a plurality of layered divisions at a predetermined interval along a plurality of first planes having an angle of 45° to the surface including the periodic pattern;
grinding a plurality of cut surfaces along the first planes of the plurality of layered divisions;
cutting each of the grinded layered divisions into a plurality of aggregates of polarizers along a plurality of second planes perpendicular to the first planes, at a plurality of positions such that each of the plurality of aggregates includes the periodic pattern; and
grinding a plurality of cut surfaces along the second planes of the plurality of aggregates of polarizers.

5. The method of claim 4, further comprising:
forming antireflection films on the grinded cut surfaces along the first planes and the grinded cut surfaces along the second planes.

6. The method of claim 5, further comprising:
forming a polarizer by cutting one of the plurality of aggregates of polarizers on which the antireflection films are formed, along a plane perpendicular to the first planes and the second planes at a predetermined length.

7. The method of claim 1,
wherein the substrate is a right-triangle pole in shape, and
the method further comprising:
jointing the substrate with a hypotenuse surface where the periodic pattern is formed and the substrate with a hypotenuse surface where the periodic pattern is not formed, with the hypotenuse surface where the periodic pattern is formed and the hypotenuse surface where the periodic pattern is not formed facing each other through an adhesive, to form an aggregate of polarizers in a rectangular parallelepiped shape.

8. The method of claim 7, further comprising:
forming antireflection films on four side surfaces of the aggregate of polarizers.

9. The method of claim 8, further comprising:
forming a polarizer by cutting the aggregate of polarizers on which antireflection films are formed, along a plane perpendicular to the periodic pattern at a predetermined length.
